(19) United States
(12) Patent Application Publication
(10) Pub. No.: US 2005/0243854 A1
(43) Pub. Date: Nov. 3, 2005

(54) Channelization apparatus and method of analyzing mobile telephony data

(76) Inventor: Robert G. Ward, Colorado Springs, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/834,167

(22) Filed: Apr. 29, 2004

(51) Int. Cl. H04J 3/00

(52) U.S. Cl. 370/437; 370/498

(57) ABSTRACT

A channelization apparatus and method for analyzing mobile telephony data, particularly in a mobile telephone network having a plurality of high-speed ports and multiple channels which are monitored simultaneously. The apparatus includes a circular buffer which stores the mobile telephony data, the mobile telephony data having timeslot data and context information that corresponds to the timeslot data; an extractor which parses the stored timeslot data into a plurality of channels, each channel having a plurality of frame fragments; a framer which accumulates the frame fragments according to the stored context information and corresponding channels using HDLC or TRAU; a packetizer which groups the accumulated frame fragments into complete frames; and a statistics unit which generates mobile telephony data usage statistics associated with each channel based on the frame fragments and complete frames is provided.

### BACKGROUND OF THE INVENTION

Mobile telephone, or cellular, networks have proliferated and the size, speed and the complexity of the networks has increased as well. Telecommunication service technologies capable of meeting such high-speed data demands include existing T1/E1 technology.

Testing is used to qualify new service installations, and to troubleshoot problems arising in existing installations. Signaling analyzers allow distributed testing and analysis to check the mobile telephone network or to troubleshoot problems.

In order to reduce costs and increase technician productivity, telecommunication service providers are increasingly equipping their service technicians with portable computers (e.g., laptop PCs) for field work management, data base access, and system testing and analysis. However, as the size and speed of mobile networks has increased the need for the ability to monitor and analyze more channels simultaneously has also increased.

Existing telecommunication test products have generally been processor based and could support only 64 channels. Thus, the existing telecommunication test products generally require complex circuitry and processors, similar to those found in personal computers. It would thus be beneficial to have an easily manufactured telecommunication test system, which may be variably configured to perform testing upon multiple high-speed ports and numerous channels simultaneously.

### BRIEF DESCRIPTION OF THE DRAWINGS

These and/or other aspects and advantages of embodiments of the present invention will become apparent and more readily appreciated from the following description of the embodiments, taken in conjunction with the accompanying drawings of which:

FIG. 1 is a flowchart illustrating a method of analyzing mobile telephony data by channelization in accordance with an embodiment of the present invention;

FIG. 2 is a block diagram of a channelization apparatus for analyzing mobile telephony data in accordance with an embodiment of the present invention;

FIG. 3 is an example of an HDLC frame processed by the framer of FIG. 2;

FIG. 4 is an example of a TRAU frame processed by the framer of FIG. 2;

FIG. 5 is a block diagram of the packetizer of FIG. 2; and

FIG. 6 is a block diagram illustrating the operation of the buffer manager of FIG. 5.

### DETAILED DESCRIPTION OF THE INVENTION

Reference will now be made in detail to the embodiments of the present invention, examples of which are illustrated in the accompanying drawings, wherein like reference numerals refer to the like elements throughout. The embodiments are described below by referring to the figures.

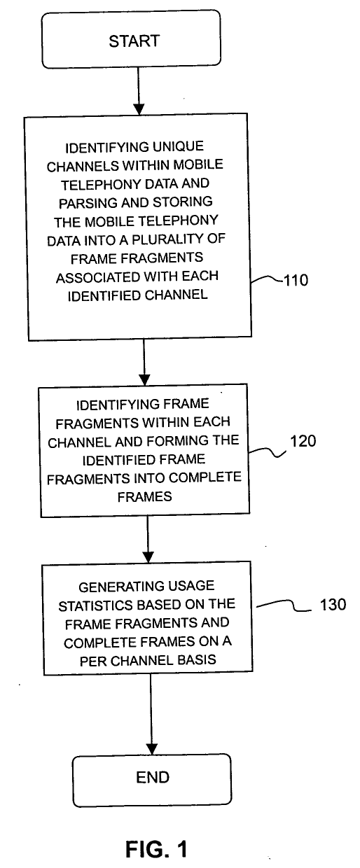

FIG. 1 is a flowchart illustrating a method of analyzing mobile telephony data by channelization in accordance with an embodiment of the present invention. Referring now to FIG. 1, in operation 110 unique channels within data that is received from a mobile telephony network from multiple inputs are identified and then the data is parsed into frame fragments associated with each channel. For example, data from up to 8 T1 or E1 ports on a 2 G or a 2.5 G mobile telephony network may be received at the same time. The frame fragments are identified as belonging to a particular channel based on values stored in a channelization table, which will be described in detail later. Typically, the data is signaling data. However, the present invention is not limited to signaling data and the data may also be other types of mobile telephony data such as voice data, text messaging data, or Internet data (such as when a cell phone is used to surf the Internet). Furthermore, embodiments of the invention are not limited to handling only T1 or E1 ports and inputs from more than 8 ports may be received to analyze multiple channels.

From operation 110, the process moves to operation 120, where frame fragments that are related to each other are identified and are formed, or grouped, into complete frames. The frame fragments are identified as belonging to a particular frame using the channelization table according to either a High Level Data Link Control protocol or a Transcoder and Rate Adapter Unit protocol. Complete frames are then formed from the identified frame fragments and then may be output to a memory where a processor (not shown) accesses the frame fragments and the processor copies and transfers the complete frames to a PC for display to a user.

From operation 120, the process moves to operation 130, where mobile telephony data usage statistics are generated based on the frame fragments and complete frames on a per channel basis. The mobile telephony data usage statistics typically comprise a total byte count, a total frame count, a total short frame count, a total aborted frame count, and a total frame checksum error frame count in some combination. These mobile telephony data usage statistics are then output to a display, a personal computer, or other device capable of interfacing with a user. The mobile telephony data usage statistics may also be stored in a memory for later retrieval by the user to study the mobile telephone network. Furthermore, the complete frames may be displayed to a user via a PC, terminal or other display device. The method may be implemented in hardware, software, or a combination of both.

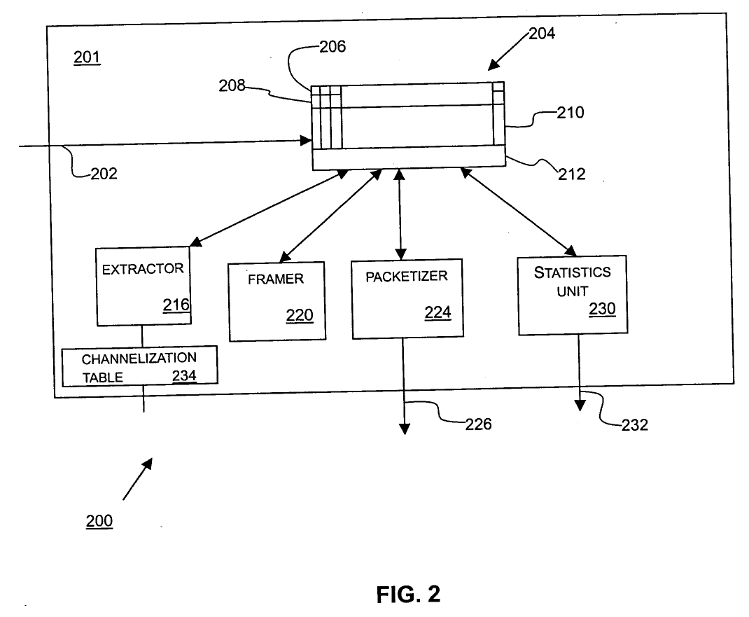

FIG. 2 is a block diagram of a channelization apparatus 200 for analyzing mobile telephony data in accordance with an embodiment of the present invention. Referring to FIG. 2, the channelization apparatus comprises a field programmable gate array (FPGA) 201 comprising a circular buffer 204, an extractor 216, a framer 220, a packetizer 224 and a statistics unit 230. A channelization table 234 is also stored in memory on the FPGA 201, though the channelization table 234 may also reside in external memory (not shown). Mobile telephony data is received on bus 202, and is stored in the circular buffer 204. The mobile telephony data is multiplexed data from the mobile network comprising up to, but not limited to, 8 T1 or 8 E1 ports. It is understood that other encoded packet data received from other types of high-speed ports may also be processed by the channelization apparatus 200.

The circular buffer 204 comprises a context information field 206, a fragmentation table 208, a data storage area 210 and an access controller 212. The circular buffer 204 stores the mobile telephony data, the mobile telephony data comprising timeslot data and context information that correspond to the timeslot data. A byte in a particular location within a T1 or E1 frame is referred to as a timeslot. The context information field 206 stores the context information corresponding to the timeslots. For example, information such as the origination port of the timeslot byte, the timeslot number and a timestamp to indicate when the timeslot byte was received. The data storage area 210 is 32 bytes and stores the received timeslots. As described more fully below, the fragmentation table 208, which is created by the extractor 216, stores entries that move along with a byte as the byte goes to each processor (i.e., the extractor 216, the framer 220, the packetizer 224, and the statistics unit 230). The access controller 212 controls communication between the circular buffer 204 and each of the extractor 216, the framer 220, the packetizer 224 and the statistics unit 230, respectively.

The access controller 212 uses pointers (not shown) to queue a byte for processing by one of the processors, which are the extractor 216, the framer 220, the packetizer 224 and the statistics unit 230, respectively. A given byte will move from one processor to another while passing through the circular buffer 204. Each processor will process bytes as long as there is a byte of data in the circular buffer 204 that has been processed by the previous processor. As each processor processes a byte the context information field 206 and fragmentation table 208 corresponding to that byte may be added to, modified or rewritten for use by the next processor. Each of the extractor 216, the framer 220, the packetizer 224 and the statistics unit 230 may process in parallel so that a high throughput can be achieved.

The extractor 216 parses the stored timeslot data into a plurality of channels, each channel having a plurality of frame fragments. Specifically, the extractor 216 reads the timeslot and port numbers for a byte and the byte from the circular buffer 204 and separates the bits in the byte into corresponding channels. The extractor 216 parses the byte by referring to a channelization table 234 using the timeslot and port numbers corresponding to that byte.

The channelization table 234 has up to 8 entries per port per timeslot because each bit of the timeslot could be used in 8 different channels. Preferably, though not required, a user, depending upon a type of communication link that the FPGA 201 is communicatively coupled with, creates the configuration of the channelization table 234 to specify, for every timeslot on every port, which bits belong to a specified channel, what framing that channel uses, what filtering is required, and what variant of the CRC is to be used. For each entry, a bit field is read from the channelization table 234 together with a channel number, framing type, filtering option, and CRC option. The channelization table 234 may also be preset to a default setting, which the user may optionally change through an input device (not shown).

The extractor 216 takes each bit field and channel number and creates an entry into the fragmentation table 208 in the circular buffer 204. Each entry in the fragmentation table 208 comprises 1 to 8 bits of the incoming data byte that are shifted down to the least significant bits in a new byte sized entry of the fragmentation table 208, the number of bits that are valid in the fragment entry data byte, and the channel number, framing type, filtering option and CRC option as read from the channelization table.

For example, assuming a timeslot is read by the extractor 216 from the circular buffer 204. The extractor will look up in the channelization table 234 an entry corresponding to that timeslot and port number and determine that bits 2, 5 and 6 of the timeslot belong to channel 1. The extractor 216 then writes these three bits as bits 0, 1 and 2 of a new byte-sized entry into the fragmentation table 208. Thus, these 3 bits corresponding to channel 1 are now a frame fragment in the fragmentation table 208 entry in the circular buffer 204 and are ready to be processed by the next processor, the framer 220.

The framer 220 accumulates the frame fragments according to the stored context information and corresponding channels. The framer 220 reads each frame fragment from the circular buffer 204 and concatenates bits from like channels from previous frame fragments and checks for a predetermined framing pattern to delineate frames. The framer 220 uses either a High Level Data Link Control (HDLC) protocol or a Transcoder and Rate Adapter Unit (TRAU) protocol to tag the accumulated frame fragments such that the packetizer 224 recognizes the accumulated frame fragments as either a beginning frame fragment, a middle frame fragment, or an end frame fragment. The framer 220 may support up to 2048 channels simultaneously.

When the framer 220 uses the HDLC protocol, the framer 220 reads a byte from the circular buffer 204 every time a new timeslot is received by the circular buffer 204 on bus 202. Associated with this read byte is an entry of the fragmentation table 208 with up to 8 frame fragments. Each frame fragment comprises data (i.e., 1 to 8 bits), the size of the data (i.e., 1 to 8), and a corresponding channel number.

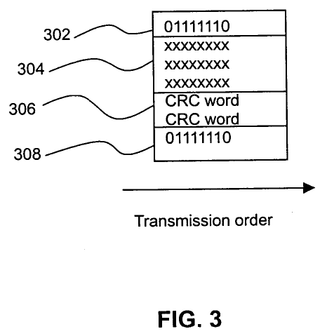

FIG. 3 is an example of an HDLC frame. Referring to the example of FIG. 3, the standard frame of the HDLC protocol handles both data and control messages. The begin indicator 302 is a pattern of 8 bits. The payload 304 may include address and data portions and is a multiple of 8 bits before zero-bit-insertion is performed. The CRC comprises a CRC word 306 of 16 bits in length. The end indicator 308, or frame delineation flag is a predetermined pattern of 8 bits. The HDLC frame may also include the Signaling System number 7 (SS7) format.

The framer 220, according to this aspect of the present invention, comprises a 24 bit shift register (not shown), a bit shift counter (not shown) and a memory (not shown). The memory is an internal memory of the FPGA 201. These components are implemented in the FPGA 201 according to an embodiment of the present invention.

More specifically, the memory is partitioned to include the following information that can be retrieved independently for each channel: the last 16 bits of the given channel bitstream (referred to as “PreviousData”); a phase indicator (0-7) that is used to convert output bits to output bytes; an indicator referred to as “NewFrame” that indicates that a new frame is about to start; an indicator referred to as “PriorZBD” that indicates a zero bit deletion (ZBD) occurred just prior to switching to another fragment; and an indicator “GotMyFirstFlag” that is used to suppress output until at least the first flag is input.

In processing data, the framer 220 processes each fragment through a series of operations. The shift register bits (15:0) are loaded with the “PreviousData” from the memory for the channel in question and the bit shift counter is initialized to zero. The remaining shift register bits (23:16) are loaded with the incoming frame fragment data (1 to 8 bits). If the “PriorZBD” indicator is set then bits (22:15) are loaded with the incoming data. This is because a zero bit had been deleted the last time a fragment for this channel was processed. The bits in the shift register are shifted right one place, the phase indicator is incremented and the bit shift counter is incremented. The phase indicator is incremented unless it has a value of 7 in which case it is set to 0. Bits (15:8) of the shift register are checked for 01111110 or 11111110 data patterns, which are the frame delineation flag and abort frame indicators, respectively. Bits (13:8) of the shift register are checked for 011111 which indicate that zero-bit-deletion needs to occur. Meanwhile, the phase indicator is checked for a value of zero and the “GotMyFirstFlag” indicator is set to indicate that at least one frame delineation flag has been detected. If “GotMyFirstFlag” is true and the phase indicator is zero then shift register bits (7:0) are output and are written back to the fragment entry in the fragmentation table 208 that is currently being processed. The begin indicator is set and “NewFrame” is negated if “NewFrame” is set but the frame delineation flag has not been detected at this moment. The end indicator is set if “NewFrame” is not set but the frame delineation flag has been detected. If neither the begin or end indicator are applicable, the indicator is set to middle which indicates that the frame fragment detected is the middle of a complete frame.

If the frame delineation flag or abort frame indicator has been detected, then the internal flag “NewFrame” is set. If the frame delineation flag has been detected then the internal flag “GotMyFirstFrame” is set. If the abort frame indicator has been detected then the internal flag “GotMyFirstFrame” is negated.

If the bit shift counter equals the size of the incoming frame fragment, then bits (15:0) of the shift register are written back to the fragment entry in the fragmentation table 208 that is currently being processed and the next frame fragment is ready to be processed. Additionally, if zero bit deletion needs to be performed then indicator “PriorZBD” is set.

If the bit shift counter does not equal the size of the incoming frame fragment, then if zero bit deletion needs to occur, bit (13) is deleted, bits (12:1) are shifted right one place and bits (23:14) are shifted right 2 places. Otherwise if there is no need of zero bit deletion then bits (23:1) are shifted right one place. Then the process continues by incrementing the phase indicator and checking for the frame delineation flag and the abort frame indicators.

Output from the framer 220 using HDLC goes out every time a byte (timeslot) is input into the channelization apparatus 200 on bus 202. Associated with this byte is a fragmentation table 208 with up to 8 frame fragments in it. Each fragment comprises: 8 bits of data; a begin, middle and end of frame indicator; a channel number; an aborted frame indicator; and a FCS error frame indicator.

When the framer 220 uses the TRAU protocol, the framer 220 reads a byte from the circular buffer 204 every time a new timeslot is received by the circular buffer 204 on bus 202. Associated with this byte is a fragmentation table with up to 8 frame fragments in it. Each frame fragment comprises data (i.e., 1 to 8 bits), the size of the data (i.e., 1 to 8), and the corresponding channel number.

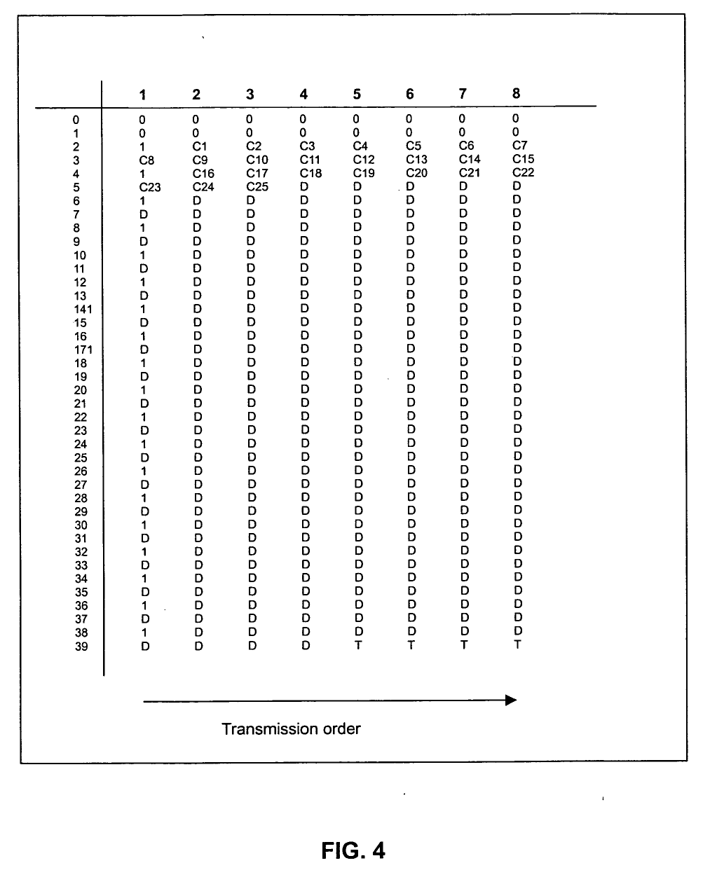

FIG. 4 is an example of a TRAU frame. Referring to the example of FIG. 4, D refers to data bits, Cn refers to control bits and T refers to timing adjustment bits. The timing adjustment bits are used when the next frame starts 4 bits earlier than the end of the current frame. It is understood that there are other variants, not shown, of the TRAU frame that can be handled by this invention with minor modifications.

The framer 220, according to this aspect of the present invention, comprises a 26 bit shift register (not shown), a bit shift counter (not shown) and a memory (not shown). The memory in an aspect of the present invention is an internal memory of the FPGA 201. The other components are also implemented in the FPGA 201 according to an embodiment of the present invention.

In this example, the memory is partitioned to include the following information that can be retrieved independently for each channel: the last 18 bits of a given channel bitstream (referred to as “PreviousData”); a phase indicator (0-7) that is used to convert output bits to output bytes; a count referred to as “BwdGuard” that records consecutive bad framing patterns that have been detected; a count referred to as “BitsFromEnd” that records how many bits are left to output of the current frame; a count referred to as “BitsFromStart” that records how many bits have been output from the current frame; and an indicator referred to as “FramingState” that indicates whether frame synchorization has been achieved.

In an operation, the framer 220 using TRAU processes each fragment through a series of operations until the frame fragments have all been identified and converted to complete frame bytes. The shift register bits (17:0) are loaded with the “PreviousData” from the memory for the channel in question and the bit shift counter is initialized to zero. The shift register bits (25:18) are loaded with the incoming frame fragment data (1 to 8 bits). Local variables are set to “BwdGuard”, “BitsFromEnd”, “BitsFromStart”, and “FramingState” as restored from the local memory entry for the channel being processed as obtained from the frame fragment. Next, the bits in the shift register are shifted right one place, the phase indicator is incremented and the bit shift counter is incremented. The phase indicator is incremented unless it has a value of 7 in which case it is set to 0. Bits (17:1) are checked for a 10000000000000000 data pattern which is the common part of the TRAU framing pattern for the various TRAU frame types. If the current framing state for this channel is out-of-frame (OOF) and a framing pattern is detected, then the framing state is set to in-frame (INF). Simultaneously “BitsFromEnd” is set to 319, “BitsFromStart” is set to 1 and “BwdGuard” is set to 0.

If the current framing state for this channel is INF and “BitsFromEnd”=0, then if a framing pattern is detected “BwdGuard” is set to 0 otherwise “BwdGuard” is incremented due to there not being a framing pattern in the expected place. If “BwdGuard” reaches the value of 3 then the framing state is set to OOF.

If the TRAU framing pattern is not detected or the framing state is not INF, then “BitsFromEnd” is decremented and “BitsFromStart” is incremented. When “BitsFromStart” reaches 17, the C1 to C5 bits are examined. If the C1 to C5 bits have certain values then the frame may be subject to Timing Adjustment Control (TAC).

If the frame is subject to TAC, then when “BitsFromStart” equals 22, the C6 to C11 bits are examined and decoded according to the TRAU standard. The result of which caused the value “BitsFromEnd” to be adjusted with the effect that the framing pattern of the next frame is tested at an offset to the normal spacing of framing patterns.

When the phase indicator is zero and the framing state is INF, bits (7:0) of the shift register are written back to the fragment entry in the fragmentation table 208 that is currently being processed. The begin indicator is set if “BitsFromStart”=1, the end indicator is set if “BitsFromStart”=313, and if neither the begin or end indicator is applicable, the indicator is set to middle.

If the bit shift counter equals the size of the incoming data, shift register bits (17:0) are written back to the fragment entry in the fragmentation table 208 that is currently being processed along with the values “BitsFromStart”, “BitsFromEnd”, “FramingState” and “BwdGuard”. The next frame fragment is then ready to be processed. Subsequent frame fragments are processed in a similar manner.

Output from the framer 220 using TRAU goes out every time a byte (timeslot) is input into the channelization apparatus on bus 202. Associated with this byte is a fragmentation table 208 with up to 8 frame fragments in it. Each fragment comprises: 8 bits of data; a begin, middle and end of frame indicator; and a channel number.

The packetizer 224 groups the accumulated byte sized frame fragments into complete frames. The packetizer 224 checks each fragment table 208 entry and builds complete frames for each channel from the incoming bytes. The packetizer 224 is able to process each channel independently of the other channels. This deinterleaving function enables the channelization apparatus to operate efficiently and process each channel separately from the other channels. According to another aspect of the invention, the packetizer can filter SS7 messages based on length field, and filter TRAU idle speech frames.

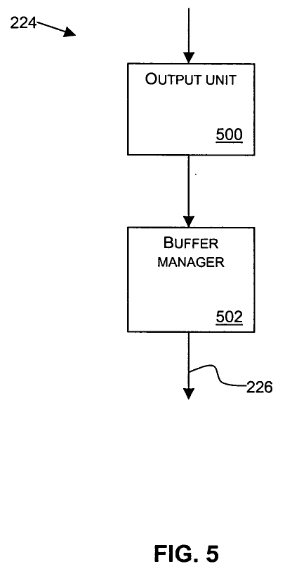

FIG. 5 is a more detailed block diagram of the packetizer 224 of FIG. 2. The packetizer 224 comprises an output unit 500 and a buffer manager 502. The output unit 500 adds a header to each beginning frame fragment and adds a trailer to each end frame fragment on a per channel basis. The buffer manager 502 groups the frame fragments from the output unit 500 corresponding to each channel into a complete frame including a beginning frame fragment, at least one middle frame fragment, and an end frame fragment. The complete frames are then sent to a memory for access by a processor that copies and transfers the frames to a PC for display to a user.

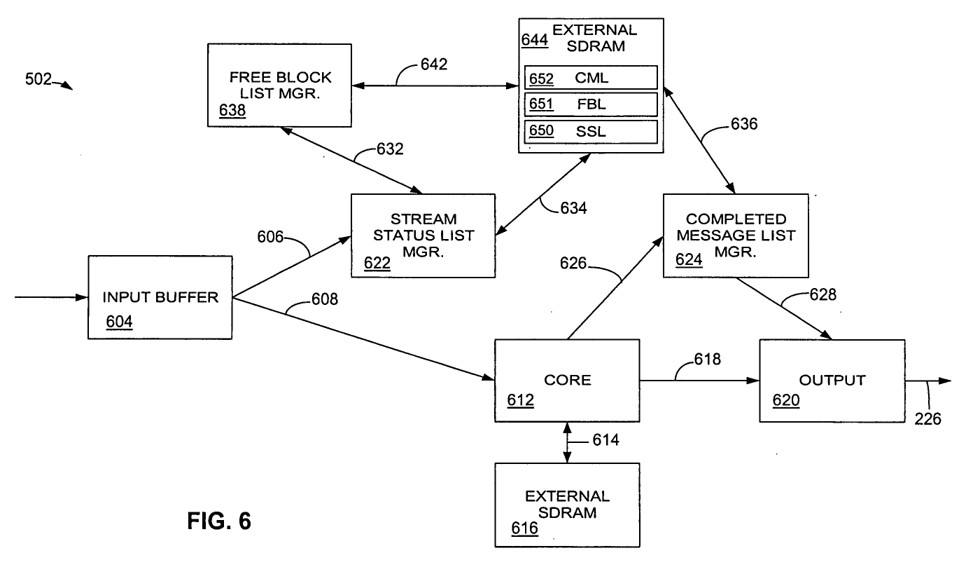

FIG. 6 is a detailed block diagram of the buffer manager 502 of FIG. 5. Referring to FIG. 6, the stream status list (SSL) 650, free block list (FBL) 651 and the completed message list (CML) 652 are lists that are maintained in external SDRAM 644. These lists are managed by the SSL manager 622, FBL manager 638 and the CML manager 624, respectively. The input buffer 604 receives a frame fragment from the output unit 500 of FIG. 5. The SSL manager 622 determines whether frame fragment is the start of a new frame, the continuation of an existing frame, or the end of an existing frame via connection 606. If the SSL 622 determines that the frame fragment is a new frame, a buffer number is obtained from the FBL manager 638 and the buffer number is saved in the SSL 650 for that index. If the SSL manager 622 determines that the frame fragment is a continuation, then, the existing buffer is obtained from the SSL 650. The core 612 writes the data to the allocated buffer within a memory, such as external SDRAM 616. The external SDRAM 616 is partitioned into many separate buffers, each large enough to hold one frame.

If the core 612 determines that an entire frame has been written, then the core 612 adds a message to the CML 652 via the completed message list (CML) manager 624. The CML manager 624 informs the output element 620 that a complete frame is waiting to be output. The output element 620 accesses the frame via the core 612 and outputs the frame via connection 226 to a memory for transfer to a PC, networked computer or other display device.

Referring again to FIG. 2, the statistics unit 230 generates mobile telephony data usage statistics associated with each channel based on the frame fragments and complete frames. The mobile telephony data usage statistics comprise a total byte count, a total frame count, a total short frame count, a total aborted frame count, and a total frame checksum error frame count in a predetermined combination.

The statistics unit 230 scans through the fragment table 208 to read bytes to generate selected statistics. The statistics may either be stored for later retrieval by a user or may be sent to a personal computer (PC) or other display device for display of the collected statistics to the user.

The embodiments of the present invention described herein are designed for use with a multi-channel mobile telephony network monitoring channelization apparatus. The channelization apparatus supports up to 2048 simultaneous channels. Because of the parallel processing structure, the channelization apparatus is fast and efficient. The channelization apparatus is implemented using an FPGA for ease of manufacturing.

Though described in embodiments of the present invention as being implemented on an FPGA, other embodiments of the present invention also can be implemented as computer readable codes in computer readable recording medium. The computer readable recording medium includes all kinds of recording apparatuses in which data that can be read by a computer system is stored. Such computer readable recording media are ROM, RAM, CD-ROM, magnetic tape, floppy disks, and optical data storage, and transmission via carrier waves, e.g., the Internet. Also, the computer readable recording medium can be distributed among computer systems connected via a network and the computer readable codes can be stored thereon and executed in a decentralized fashion.

The many aspects and advantages of embodiments of the present invention are apparent from the detailed specification and, thus, it is intended by the appended claims to cover all such features and advantages of the embodiments of the invention that fall within the true spirit and scope of the invention. Further, since numerous modifications and changes will readily occur to those skilled in the art, it is not desired to limit the invention to the exact construction and operation of the embodiments illustrated and described, and accordingly all suitable modifications and equivalents may be resorted to, falling within the scope of the invention. For example, the process in FIG. 1 is an example and modifications are possible, and the channelization apparatus in FIG. 2 is an example FPGA embodiment though modifications and constructions using external components in substitution are possible.

1. A method of analyzing mobile telephony data, comprising:
identifying unique channels within the mobile telephony data and parsing and storing the mobile telephony data into a plurality of frame fragments associated with each identified channel;
identifying related frame fragments within each identified channel and forming the identified related frame fragments into complete frames; and
generating mobile telephony data usage statistics based on the frame fragments and complete frames on a per channel basis.

2. The method of claim 1, wherein the plurality of inputs comprise up to 8 T1 ports or 8 E1 ports.

3. The method of claim 1, wherein the data comprises at least one of mobile telephony network data, mobile telephony signaling data and mobile telephony voice having been encoded as packet data.

4. The method of claim 1, wherein the identifying of the frame fragments as belonging to a particular channel is based on values stored in a channelization table.

5. The method of claim 4, wherein the identifying of the frame fragments as belonging to a particular frame according to a High Level Data Link Control protocol.

6. The method of claim 4, wherein the identifying the frame fragments as belonging to a particular frame according to a Transcoder and Rate Adapter Unit protocol.

7. The method of claim 1, wherein the mobile telephony usage statistics comprise at least one of a total byte count, a total frame count, a total short frame count, a total aborted frame count, and a total frame checksum error frame count.

8. A channelization apparatus for analyzing mobile telephony data, comprising:
a circular buffer which stores the mobile telephony data, the mobile telephony data comprising timeslot data and context information that corresponds to the timeslot data;
an extractor which parses the stored timeslot data into a plurality of channels, each channel having a plurality of frame fragments;
a framer which accumulates the frame fragments according to the stored context information and corresponding channels;
a packetizer which groups the accumulated frame fragments into complete frames; and
a statistics unit which generates mobile telephony data usage statistics associated with each channel based on the frame fragments and complete frames.

9. The apparatus of claim 8, wherein the circular buffer communicates with the extractor, the framer, the packetizer and the statistics unit simultaneously.

10. The apparatus of claim 9, further comprising:
a channelization table which stores entries which identify which bits of each timeslot correspond to the channel.

11. The apparatus of claim 10, wherein the framer tags the accumulated frame fragments such that the packetizer recognizes the accumulated frame fragments as one of a beginning frame fragment, a middle frame fragment, and an end frame fragment.

12. The apparatus of claim 11, wherein the framer uses a High Level Data Link Control protocol in a 2 G or 2.5 G mobile telephony system.

13. The apparatus of claim 11, wherein the framer uses a Transcoder and Rate Adapter Unit protocol in a 2 G or 2.5 G mobile telephony system.

14. The apparatus of claim 11, wherein the packetizer comprises:
an output unit which adds a header to each beginning frame fragment and adds a trailer to each end frame fragment on a per channel basis; and
a buffer manager which compiles the frame fragments from the output unit corresponding to each channel into a complete frame.

15. The apparatus of claim 10, wherein the mobile telephony data usage statistics comprise at least one of a total byte count, a total frame count, a total short frame count, a total aborted frame count, and a total frame checksum error frame count.

16. The apparatus of claim 15, wherein the mobile telephony data comprises at least one of mobile telephony network data, signaling data and mobile telephony voice having been encoded as packet data.

17. The apparatus of claim 16, wherein at least one of the mobile telephony usage statistics, the mobile telephony network data, the signaling data, and the complete frames are output for display.

18. A method of analyzing mobile telephony data, comprising:
monitoring mobile telephony data, the data comprising a plurality of channels having frame fragments, from a plurality of ports simultaneously;
grouping the mobile telephony data into complete frames from the frame fragments within each of the channels; and
gathering mobile telephony data statistics based on the complete frames and the frame fragments on a per channel basis.

19. The method of claim 18, wherein the plurality of ports comprises up to 8 T1 or E1 ports.

20. The method of claim 19, wherein the mobile telephony data comprises at least one of mobile telephony network data and mobile telephony signaling data.

21. The method of claim 20, further comprising:
deinterleaving the fragments into the complete frames such that each frame corresponding to respective channels may be grouped independent of the other frames.

22. The method of claim 21, wherein the mobile telephony data statistics comprise at least one of a total byte count, a total frame count, a total short frame count, a total aborted frame count, and a total frame checksum error frame count.

23. The method of claim 22, further comprising:
displaying at least one of the mobile telephony data statistics, the mobile telephony network data and the mobile telephony signaling data to a user.

24. A system for analyzing mobile telephony data, comprising:
means for separating and storing mobile telephony data from a plurality of inputs into channels;
means for identifying frame fragments within each channel and grouping the frame fragments into complete frames for each channel; and
means for storing mobile telephony usage statistics based on the identified frame fragments and complete frames on a per channel basis.
